(19) United States
(12) Patent Application Publication
(10) Pub. No.: US 2013/0011669 A1
(43) Pub. Date: Jan. 10, 2013

(54) Multi-Layer Films Having Improved Sealing Properties

(76) Inventors: Pang-Chia LU, Pittsford, NY (US); George F. Cretekos, Farmington, NY (US)

(21) Appl. No.: 13/484,941

(22) Filed: May 31, 2012

Related U.S. Application Data
(60) Provisional application No. 61/505,733, filed on Jul. 8, 2011.

(51) Int. Cl. B32B 27/08; B29C 43/30; B32B 27/32

(52) U.S. Cl. 428/349; 264/173.1

(57) ABSTRACT

Heat-sealable, oriented, multilayer films including i) a polyolefin core layer; and ii) a heat-sealable layer a blend of 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.). In particular films, the heat-sealable layer has a Haze of ≦5.0 and a seal strength of ≧3.00×10² g/2.54 cm at 90° C. (194° F.). Methods of making such multilayer structures and articles made therefrom are also disclosed.

### PRIORITY CLAIM

This application claims the benefit and priority to U.S. Ser. No. 61/505,733, filed Jul. 8, 2011 which is referenced in its entirety.

### FIELD OF THE INVENTION

Embodiments of the invention relate to heat-sealable multilayer films. In particular, this disclosure relates to such multilayer films that provide high seal strengths at low temperatures.

### BACKGROUND OF THE INVENTION

Polypropylene-based multi-layer films are widely used in packaging applications, such as flexible packaging for snack foods, dry food mixes, pet foods, and seeds. Such multi-layer films must have the ability to form reliable seals at relatively low temperature and, in some instances, the film must do so in the presence of contamination from the contents of the packaging.

Film processing can be limited, however, if a strong reliable seal can not be formed sufficiently fast enough during the heat-sealing step. Thus, one feature of a heat-sealable film is the minimum temperature at which the film forms a reliable seal. This temperature is referred to as the minimum seal temperature (MST) and is conveniently designated as the temperature at which the seal strength achieves a value of 2.00×10² g/2.54 cm at 82° C.

While a lower MST may provide a suitable seal at a lower temperature, a low MST can present difficulties in the orientation step of the film manufacturing process. For example, a low MST may be accomplished by using a low melting polymer in the heat-sealable layer. The low melting polymer, however, tends to melt when the film is heated prior to stretching. The heat-sealable layer then tends to stick to orientation rolls when stretched using a sequential tenter process. To avoid this problem, orientation by simultaneous tentering process has been used. Simultaneous tenter orientation is much more costly and complicated than sequential orientation using differential speed rollers and subsequent orientation by tentering.

Accordingly, there remains a need in the industry for heat-sealable clear packaging films and processes for making such films that provide an acceptable combination of seal strength, machinability, optical properties, and improved MSTs that do not require simultaneous tenter orientation.

### SUMMARY OF THE INVENTION

In one aspect, embodiments of the invention provide a heat-sealable, oriented, multilayer film comprising i) a polyolefin core layer; and ii) a heat-sealable layer comprising a blend, wherein the blend comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.). In particular embodiments, the heat-sealable layer comprises 15.0 wt % to 30.0 wt % of a propylene-butene copolymer elastomer and 70.0 wt % to 85.0 wt % of a propylene-ethylene random copolymer.

In another aspect, embodiments of the invention provide a heat-sealable, oriented, multilayer film comprising i) a polyolefin core layer; and ii) a heat-sealable layer comprising a blend, wherein the blend comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧3.00×10² g/2.54 cm at 90° C. (194° F.).

In another aspect, embodiments of the invention provide a method of making a heat-sealable, oriented film, the method comprising a) coextruding a film comprising i) a polyolefin core layer and ii) a heat-sealable layer comprising a compatible blend, wherein the compatible blend comprises 10.0 wt % to 50.0 wt % of a propylene-based elastomer and 50.0 wt % to 90.0 wt % of a propylene-based polymer compatible with the propylene-based elastomer; b) orienting the film in the machine direction, wherein the heat-sealable layer contacts one or more rollers; and c) optionally orienting the film in the transverse direction.

These and other features, aspects, and advantages of the present disclosure will become better understood with regard to the following description and appended claims.

### BRIEF DESCRIPTION OF FIGURES

FIG. 1 represents the seal performance of films according to particular embodiments of the invention.

### DETAILED DESCRIPTION

Particular embodiments of the invention described herein are believed to provide sealing properties, e.g., minimum seal temperature, of films and laminated structures. Selected embodiments of such films and laminated structures will now be described in more detail, but this description is not meant to foreclose other forms within the broader scope of this disclosure.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise.

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein. For instance, all numbers disclosed herein are approximate values, regardless whether the word “about” or “approximate” is used in connection therewith. They may vary by 1%, 2%, 5%, and sometimes, 10% to 20%. Whenever a numerical range with a lower limit, R^{L} and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1% to 100% with a 1% increment, i.e., k is 1%, 2%, 3%, 4%, 5%, . . . , 50%, 51%, 52%, . . . , 95%, 96%, 97%, 98%, 99%, or 100%. Moreover, any numerical range defined by two R numbers as defined in the above is also specifically disclosed.

For the purpose of this description and the appended claims, the term “polymer” means a composition including a plurality of macromolecules, the macromolecules containing recurring units derived from one or more monomers. The term “polymer” includes macromolecules, such as copolymer, terpolymer, etc., and encompasses individual polymer components and blends thereof, e.g., physical blends, solution blends, and/or reactor blends.

The term “polyolefin” means a polymer containing recurring units derived from olefin, e.g., poly-α olefin such as polypropylene and/or polyethylene.

“Polypropylene” and “propylene-based” refer to a polyolefin containing recurring propylene-derived units, e.g., polypropylene homopolymer, polypropylene copolymer, etc., wherein >50%, preferably >70% or >85%, (by number) of the recurring units are derived from propylene monomer.

“Polyethylene” and “ethylene-based” refer to a polyolefin containing recurring ethylene-derived units, e.g., polyethylene homopolymer, polyethylene copolymer, etc., wherein >50%, preferably >70% or >85%, (by number) of the recurring units are derived from ethylene monomer.

As used herein, the term “isotactic” is defined as polymeric stereoregularity having at least 40% isotactic pentads of methyl groups derived from propylene according to analysis by ¹³C-NMR.

As used herein, “stereoregular” is defined to mean that the predominant number, e.g., >50%, >60%, >70%, or >80%, of the propylene units in the polypropylene or in the polypropylene continuous phase of a blend, such as impact copolymer exclusive of any other monomer such as ethylene, has the same 1,2 insertion and the stereochemical orientation of the pendant methyl group is the same, either meso or racemic.

“Copolymer” means a polymer containing recurring units derived from at least two different monomers, preferably, e.g., olefins such as ethylene, propylene, butenes, etc. Thus, a propylene copolymer or propylene-based polymer contains at least two different monomers wherein >50%, preferably >70% or >85%, (by number) of the recurring units are derived from propylene monomer.

“Terpolymer” means a polymer containing recurring units derived from at least three different monomers, preferably, e.g., olefins such as ethylene, propylene, butenes, etc. Thus, a propylene terpolymer or propylene-based terpolymer contains at least three different monomers wherein >50%, preferably >70% or >85%, (by number) of the recurring units are derived from propylene monomer.

As used herein, “intermediate” is defined as the position of one layer of the multilayer film wherein said layer lies between two other identified layers. In some forms, the intermediate layer may be in direct contact with either or both of the two identified layers. In other forms, additional layers may also be present between the intermediate layer and either or both of the two identified layers.

As used herein, “substantially free” is defined to mean that the referenced film layer is largely, but not necessarily wholly, absent a particular component. In some forms, the layer is completely free of the particular component; however, in other forms, small amounts of the component may be present within the referenced layer as a result of standard manufacturing methods, including recycling of film scraps and edge trim during processing.

The term “compatible” as it refers to polymeric components describes a composition wherein the components are not present in distinct morphological phases in the same state. For example, polymeric components of blend wherein one polymer forms discrete packets dispersed in a matrix of another polymer in the solid state would not be “compatible.” But polymeric components of blend wherein one polymer is dispersed in a matrix of another polymer in the solid state would be “compatible.” Such morphologies may be determined visually, or alternatively, using scanning electron microscopy (SEM) or atomic force microscopy (AFM). In the event the SEM and AFM provide different data, then the AFM data are used.

Embodiments of the invention provide a multi-layer structure suitable for processes where a sealable film with a low minimum seal temperature is stretched in at least the machine direction through differential speed rollers. Optionally, embodiments of the invention may also have improved seal temperature range. The multi-layer structure includes an oriented multilayer polymeric film and, optionally, a substrate in surface contact with the multilayer polymeric film. The oriented multilayer polymeric film can be of any design provided that the heat-sealable layer comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.). In particular embodiments, the heat-sealable layer comprises 15.0 wt % to 30.0 wt % of a propylene-butene copolymer elastomer and 70.0 wt % to 85.0 wt % of a propylene-ethylene random copolymer.

### Heat Sealable Skin Layer

The heat-sealable layer comprises a propylene-based elastomer, a propylene-based polymer, includes less than 1.0 wt % ethylene homopolymer or ethylene-based copolymer and has a Haze of ≦5.0 and a seal strength of ≧2.00×10² g/2.54 cm at 82° C. (180° F.).

### Propylene-Based Elastomer

The propylene-based elastomer typically comprises 10.0 wt % to 50.0 wt % of the heat-sealable layer. In embodiments of the invention, the lower limit on the amount of propylene-based elastomer can be 12.0 wt %, 13.5 wt %, 15.0 wt %, 17.5 wt %, 20.0 wt %, 22.5 wt %, 25.0 wt %, 30.0 wt %, 35.0 wt % or 40.0 wt %. Likewise, the upper limit may be 13.5 wt %, 15.0 wt %, 17.5 wt %, 20.0 wt %, 22.5 wt %, 25.0 wt %, 27.5 wt %, 30.0 wt %, 32.5 wt %, 35.0 wt %, 40.0 wt %, or 45.0 wt %. In particular embodiments, the heat-sealable layer comprises 20.0 wt % to 40.0 wt %, particularly 15.0 wt % to 30.0 wt %, of the propylene-based elastomer.

In an embodiment, the propylene-based elastomer has an isotactic propylene triad tacticity of from 65% to 95%, a melting point by DSC≦110° C., a heat of fusion of from 5 to 50 J/g, and comprises:

(1) propylene-derived units in an amount of at least 75 wt %;

(2) ethylene-derived units in an amount of at least 6 wt %; based on the combined weight of components (1), (2), and (3); and

(3) optionally 10 wt % or less of diene-derived units, wherein each of the above amounts is based on the combined weight of components (1), (2), and (3). In certain embodiments, the propylene-based elastomer has a melting temperature (Tₘ) in the range of about 50° C. to about 150° C., preferably in the range of about 55° C. to about 80° C.

Some propylene-based elastomers have a single-peak melting transition as determined by DSC. Some propylene-based elastomers have a primary peak melting transition from <90° C., with a broad end-of-melt transition from >110° C. The peak “melting point” (Tm) is defined as the temperature of the greatest heat absorption within the range of melting of the sample. However, the propylene-based elastomer may show secondary melting peaks adjacent to the principal peak, and/or the end-of-melt transition, but for purposes herein, such secondary melting peaks are considered together as a single melting point, with the highest of these peaks being considered the Tm of the propylene-based elastomer. Some propylene-based elastomers may not have a discernable melting peak.

The procedure for DSC determinations is as follows. About 0.5 grams of polymer is weighed out and pressed to a thickness of about 15-20 mils (about 381-508 nm) at about 140° C. to 150° C., using a “DSC mold” and Mylar™ as a backing sheet. The pressed pad is allowed to cool to ambient temperature by hanging in air (the Mylar is not removed). The pressed pad is annealed at room temperature (about 23° C. to about 25° C.) for about 8 days. At the end of this period, the resulting 15-20 mg disc is removed from the pressed pad using a punch die and is placed in a 10 μliter aluminum sample pan. The sample is placed in a differential scanning calorimeter (Perkin Elmer Pyris 1 Thermal Analysis System) and cooled to about −100° C. The sample is heated at about 10° C./min to attain a final temperature of about 165° C. The thermal output, recorded as the area under the melting peak of the sample, is a measure of the heat of fusion and can be expressed in Joules per gram (J/g) of polymer and is automatically calculated by the Perkin Elmer System. Under these conditions, the melting profile shows two (2) maxima, the maximum at the highest temperature was taken as the melting point within the range of melting the sample relative to a baseline measurement for the increasing heat capacity of the polymer as a function of temperature.

In some embodiments, the propylene-based elastomer is essentially free of polymer units derived from C₄-C₁₀ α-olefins (i.e., contains <1.0 wt % of units derived from an α-olefin comonomer other than propylene or ethylene). Particularly useful propylene-based elastomers are propylene-ethylene elastomers that are essentially free of units derived from butene. Preferably, the propylene-based elastomer includes from 6.0 wt % to 18.0 wt %, particularly 10.0 wt % to 18.0 wt % ethylene-derived units, more particularly, 15.0 wt % to 18.0 wt % ethylene-derived units.

Particular propylene-based elastomers comprise 1)>80.0 wt % propylene-derived units; 2) 14.0 wt % to about 18.0 wt % ethylene-derived units; (3)<2.0 wt % of diene-derived units, wherein each of the above amounts is based on the combined weight of components (1), (2), and (3); 4) a Vicat softening temperature of about 55° C. to about 65° C.; 5) a Shore A Hardness measured according to ASTM of 60 to 75 at 15 seconds and 23° C. (73° F.); 6) a density of 0.855 to 0.875 g/cm³; 7) an MFR at 230° C./2.16 kg of 1.5 to 4.5 g/10 min; and 8) an elongation at break of ≧300%, preferably ≧500% or ≧700%.

Propylene-based elastomers are also described in WO 05/049670, the disclosure of which is incorporated herein by reference in its entirety.

Preferred propylene-based elastomers are available under the trade name Vistamaxx™ (ExxonMobil Chemical Company, Houston, Tex., USA), particularly Vistamaxx™ 3020 (ethylene content: 10.5 wt %), Vistamaxx™ 3980 (ethylene content: 8.5 wt %), and Vistamaxx™ 6120 ethylene content: 16 wt %). Other suitable elastomers include Versify™ elastomers, particularly grades DP3200.01 having an ethylene content of 9 wt % (Dow Chemical Company, Midland, Mich., USA), and Mitsui Chemical's Notio™ series having Tm about 100° C. or greater, such as, PN-2070, PN-3560, PN-0040, and PN-2060.

In one embodiment, the propylene-based elastomer includes 8.0 wt % to 17.0 wt % units derived from ethylene and has a density of 0.860 to 0.890 g/cm³, a melt index of from 0.7 to 1.5 dg/min, an MFR of from 1.5 to 10.0, a Vicat softening point of 55.0 to 80.0° C., and is present in an amount of 10.0 wt % to 20.0 wt % based on the total weight of components in the heat sealable skin layer.

In some embodiments, the propylene-based elastomer is a propylene-butene elastomer. Particularly suitable elastomers are metallocene-catalyzed propylene-butene random elastomers, preferably having 20.0 wt % to 40.0 wt % of units derived from butene. The metallocene catalysis of such elastomers results in a narrow molecular weight distribution; typically, Mw/Mn is about 2.0, but may range from about 1.5 to about 7.0.

Suitable propylene-butene elastomers include those manufactured by Mitsui Chemicals under the tradename TAFMER™ and grade names XM7070 and XM7080. XM7070 has a butene content of about 26 wt % while that of XM7080 is about 22 wt %. They are characterized by a melting point of 75° C. and 83° C., respectively; a Vicat softening point of 67° C. and 74° C., respectively; a density of 0.883-0.885 g/cm³; a Tg of about −15° C.; a melt flow rate (ASTM D-1238 at 230° C./2.16 kg) of 7.0 g/10 minutes; and a molecular weight of 190,000-192,000 g/mol. XM7070 is preferred in some embodiments due to its higher butene content.

These propylene-butene elastomers differ from Ziegler-Natta catalyzed propylene-butene elastomers such as Mitsui's TAFMER™ grade XR110T. XR110T has a butene content of about 25.6 wt % and molecular weight of about 190,185 g/mol which is similar to XM7070, but its density of 0.89 g/cm³, melting point of 110° C., and Vicat softening point of 83° C. are all higher than its metallocene-catalyzed counterpart XM7070 propylene-butene elastomer. Additionally, due to the Ziegler catalyst system, the molecular weight distribution of the non-metallocene catalyzed propylene-butene elastomer XR110T is much wider than the metallocene-catalyzed propylene-butene elastomer XM7070. Consequently, the properties and heat sealable properties of a non-metallocene-catalyzed propylene-butene elastomer are much different from a metallocene-catalyzed propylene-butene elastomer.

In certain embodiments, the propylene-based elastomers have a triad tacticity of three propylene units, as measured by ¹³C NMR, from >75% or 80% or 82% or 85% or 90%.

In one embodiment, the triad tacticity is within the range from 50% to 99%, and from 60% to 99% in another embodiment, and from 75% to 99% in yet another embodiment, and from 80% to 99% in yet another embodiment; and from 60% to 97% in yet another embodiment. Triad tacticity is determined as follows: the tacticity index, expressed herein as “m/r”, is determined by ¹³C nuclear magnetic resonance (NMR). The tacticity index m/r is calculated as defined by H. N Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer and an m/r ratio of 2.0 an atactic material. An isotactic material theoretically may have a ratio approaching infinity, and many by-product atactic polymers have sufficient isotactic content to result in ratios from >50. Embodiments of the propylene-based elastomer have a tacticity index m/r of from 4 to 12, preferably 6 to 10.

In certain embodiments, the propylene-based elastomers have a heat of fusion (H_{f}), determined according to the Differential Scanning calorimetry (DSC) procedure described herein, of <75.0, <65.0, <55.0, <50.0 J/g. In certain embodiments, the H_{f} value is within the range from 0.5, 1.0 or 5.0 J/g to 35.0, 40.0, 50.0, 65.0, to 75.0 J/g.

In certain embodiments, the propylene-based elastomers have a percent crystallinity within the range from 0.5% to 40%, and from 1% to 30% in another embodiment, and from 5% to 25% in yet another embodiment, wherein “percent crystallinity” is determined according to the DSC procedure described herein. (The thermal energy for the highest order of polypropylene is estimated at 189 J/g (i.e., 100% crystallinity is equal to 189 J/g).) In another embodiment, the propylene-based elastomer has a percent crystallinity <40% or 25% or 22% or 20%.

In certain embodiments, propylene-based elastomers useful in this invention have a density within the range from 0.840 to 0.920 g/cm³, and from 0.845 to 0.900 g/cm³ in another embodiment, and from 0.850 to 0.890 g/cm³ in yet another embodiment, the values measured at room temperature per the ASTM D-1505 test method.

The propylene-based elastomers typically have a Shore A hardness (ASTM D2240) of from 10 or 20 to 80 or 90 Shore A. In yet another embodiment, the propylene-based elastomers possess an Ultimate Elongation >5.0×10²% or 1.0×10³% or 2.0×10³%; and within the range from 3.0×10²% or 4.0×10²% or 5.0×10²% to 8.0×10²% or 1.2×10³% or 1.8×10³% or 2.0×10³% or 3.0×10³% in other embodiments.

In certain embodiments, the propylene-based elastomers have a weight average molecular weight (Mw) value within the range from 2.0×10⁴ to 5.0×10⁶ g/mole, and from 5.0×10⁴ to 1×10⁶ g/mole in another embodiment, and from 7.0×10⁴ to 4.0×10⁵ g/mole in yet another embodiment. In another embodiment, the propylene-based elastomers have a number average molecular weight (Mn) value within the range from 4.5×10³ to 2.5×10⁶ g/mole, and from 2.0×10⁴ to 2.5×10⁵ g/mole in yet another embodiment, and from 5.0×10⁴ to 2.0×10⁵ g/mole in yet another embodiment. In yet another embodiment, the propylene-based elastomers have a z-average molecular weight (Mz) value within the range from 2.0×10⁴ to 7.0×10⁶ g/mole, and from 1.0×10⁵ to 7.0×10⁵ g/mole in another embodiment, and from 1.4×10⁵ to 5.0×10⁵ g/mole in yet another embodiment.

In certain embodiments, the propylene-based elastomers have a melt flow rate (“MFR,” ASTM D1238, 2.16 kg, 230° C.), <90.0 or <70.0 or <50.0 or <40.0 or <30.0 or <20.0 or <10.0 dg/min. In some embodiments, the lower limit on the MFR is 0.1, 0.5, 1.0, 5.0, 10.0, 20.0, 30.0, 40.0, 50.0, or 70.0 dg/min in other embodiments.

In certain embodiments, a desirable molecular weight (and hence, a desirable MFR) is achieved by visbreaking the propylene-based elastomers. “Visbroken propylene-based elastomers” (also known in the art as “controlled rheology” or “CR”) are copolymers that have been treated with a visbreaking agent such that the agent breaks apart the polymer chains. Non-limiting examples of visbreaking agents include peroxides, hydroxylamine esters, and other oxidizing and free-radical generating agents. Stated another way, the visbroken copolymer may be the reaction product of a visbreaking agent and the copolymer. In particular, a visbroken propylene-based elastomer is one that has been treated with a visbreaking agent such that its MFR is increased, in one embodiment, by at least 10%, and at least 20% in another embodiment relative to the MFR value prior to treatment.

In certain embodiments, the molecular weight distribution (MWD) of the propylene-based elastomers is within the range from 1.5 or 1.8 or 2.0 to 3.0 or 3.5 or 4.0 or 5.0, or 10.0 in particular embodiments. Techniques for determining the molecular weight (Mn, Mz, and Mw) and molecular weight distribution (MWD) are as follows, and as by Verstate et al. in 21 MACROMOLECULES 3360 (1988). Conditions described herein govern over published test conditions. Molecular weight and molecular weight distribution are measured using a Waters 150 gel permeation chromatograph equipped with a Chromatix KMX-6 on-line light scattering photometer. The system is used at 135° C. with 1,2,4-trichlorobenzene as the mobile phase. Showdex™ (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes ed., Marcel Dekker, 1981). No corrections for column spreading were employed; however, data on generally accepted standards, for example, National Bureau of Standards, Polyethylene (SRM 1484) and anionically produced hydrogenated polyisoprenes (an alternating propylene-ethylene copolymer) demonstrate that such corrections on Mw/Mn or Mz/Mw are less than 0.05 units. Mw/Mn is calculated from an elution time-molecular weight relationship whereas Mz/Mw is evaluated using the light scattering photometer. The numerical analyses can be performed using the commercially available computer software GPC2, MOLWT2 available from LDC/Milton Roy-Riviera Beach, Fla.

### Propylene-Based Polymer

The propylene-based polymer typically comprises 50.0 wt % to 90.0 wt % of the heat-sealable layer. In embodiments of the invention, the lower limit on the amount of propylene-based polymer can be 88.0 wt %, 86.5 wt %, 85.0 wt %, 82.5 wt %, 80.0 wt %, 77.5 wt %, 75.0 wt %, 70.0 wt %, 65.0 wt %, or 60.0 wt %. Likewise, the upper limit may be 86.5 wt %, 85.0 wt %, 82.5 wt %, 80.0 wt %, 77.5 wt %, 75.0 wt %, 72.5 wt %, 70.0 wt %, 67.5 wt %, 65.0 wt %, 60.0 wt %, or 55.0 wt %. In particular embodiments, the heat-sealable layer comprises 60.0 wt % to 80.0 wt %, particularly 70.0 wt % to 85.0 wt %, of the propylene-based polymer.

The propylene-based polymer typically includes at least one polymer that is suitable for heat-sealing or bonding, when crimped between heated crimp-sealer jaws, fin, or lap sealing jaws.

Preferably, the propylene-based polymer comprises a polymer that has a reduced melting temperature, as compared to more crystalline polymers. A lower crystallinity (and thus, lower specific heat of fusion (ΔH)) material is desired as they generally provide better sealability. In a preferred embodiment, the propylene-based polymer has a ΔH of less than about 80 J/g, or more preferably less than about 75 J/g. Preferred propylene-based polymers have a ΔH in the range of about 40 J/g to about 80 J/g, or more preferably in the range of about 50 J/g to about 75 J/g.

The propylene-based polymer may be a propylene homopolymer, a copolymer, or terpolymer of propylene, or a mixture thereof. The propylene-based polymer can be manufactured in any conventional manner using Ziegler-Natta or metallocene catalysts or any other suitable catalyst system.

The propylene-based polymer may additionally include at least one of ethylene-propylene random copolymers, LDPE, linear low density polyethylene (LLDPE), medium density polyethylene (MDPE), and combinations thereof.

Examples of suitable propylene-based polymers include: JPC 7794 and JPC 7510, both EPB terpolymers available from Japan Polypropylene Corp; PB0300M available from Basell; and Adsyl 3C30FHP available from Basell. In particular embodiments, the propylene-based polymer comprises EP-8573, available from Total Petrochemical Company.

### Core Layer

The core layer of a multilayer film is most commonly the thickest layer of the film and provides the foundation of the multilayer structure. In some embodiments, the core layer comprises a polyolefin core layer, which may comprise a propylene polymer, ethylene polymer, isotactic polypropylene (“iPP”), high crystallinity polypropylene (“HCPP”), low crystallinity polypropylene, isotactic and syndiotactic polypropylene, ethylene-propylene (“EP”) copolymers, and combinations thereof.

In a preferred embodiment, the core layer is an iPP homopolymer. Examples of suitable commercially available iPP include: PP4712E1 from ExxonMobil Chemical

Company and Total Polypropylene 3371 from Total Petrochemicals. An example of a useful HCPP is Total Polypropylene 3270 (commercially available from Total Petrochemicals).

The core layer preferably has a thickness in the range of about 5 μm to about 50 μm, or about 5 ρm to 40 μm, and more preferably 5 μm to 25 μm, or 5 μm to 10 μm.

In a preferred embodiment, the core layer further comprises a nucleating agent. An exemplary nucleating agent for use in a polypropylene core layer can be one that induces crystallization at a temperature near the melting point of polypropylene but by itself is solid at such a temperature. In other words, a good nucleating agent may be an organic material that has a crystallization temperature above that of polypropylene and is compatible with polypropylene at melting conditions.

Extremely high melting point materials or ground inorganic materials may be used as nucleating agents in the present disclosure. The use of organic materials may be advantageous under extrusion conditions because high melting point organic materials may be non-particulate and as such may be more readily and uniformly dispersed into the polypropylene melt. Upon cooling, the organic material will solidify throughout the polypropylene melt matrix. In this manner, a true nucleating effect can be obtained.

In one embodiment, a polypropylene resin may be used which includes a nucleating agent that may be a non-particulate mix of carboxylic acids.

Combinations of suitable nucleating agents may also be used. Any suitable nucleating agent may be used if the nucleating agent is sufficiently well dispersed throughout the resin.

Examples of suitable commercially available nucleating agents that can be utilized in the multilayer film include, but are not limited to: 2,4-dimethylbenzilidene sorbitol, available as MILLAD® 3988; disodium (1R,2R,3S,4S)-rel-bicyclo[2.2.1]heptane-2,3-dicarboxylic acid, available as HYPERFORM® HPN-68L both from Miliken Chemicals; N,N′-dicyclohexyl-2,6-napthalenecarboxamide and the family of substituted 1,3,5-benzenetrisamid; and sodium 2,2′-methylene bis(4,6-di-tert-butylphenyl)phosphate, available as IRGASTAB® NA 11 from Ciba Specialty Chemicals of Switzerland.

In another embodiment, the core layer may comprise a nucleated polypropylene. An example of a suitable commercially available nucleated polypropylene is FF035C available from Sunoco Chemicals. A polypropylene that has been previously nucleated may be preferred, to ensure that the nucleating agent is sufficiently well dispersed throughout the resin in the core layer.

Preferably, the core layer further comprises a water vapor transmission inhibitor, such as, for example, a hydrocarbon resin (“HCR”). In one embodiment, the core layer includes a low molecular weight HCR that is compatible with polypropylene. An exemplary HCR has a suitable number average molecular weight, for example a number average molecular weight less than about 5000, preferably less than about 2000, and more preferably from about 500 to about 1000. The HCR can be natural or synthetic and can have a suitable softening point, for example from about 60° C. to about 180° C., preferably from about 80° C. to 130° C. (as determined according to ASTM-E 28). Exemplary HCRs can include petroleum resins, terpene resins, styrene resins, cyclopentadiene resins, and saturated alicyclic resins, among others.

Suitable petroleum resins can be those prepared in the presence of a catalyst or may be thermally polymerized petroleum materials. These petroleum materials can contain a mixture of resin-forming substances such as ethylindene, butadiene, isoprene, piperylene, pentylene, polystyrene, methylstyrene, vinyltoluene, indene, polycyclopentadiene, polyterpenes, polymers of hydrogenated aromatic hydrocarbons, alicyclic hydrocarbon resins, and combinations thereof.

The styrene resins can be homopolymers of styrene or copolymers of styrene with other monomers, such as, for example, alpha methylstyrene, vinyltoluene, and butadiene.

The cyclopentadiene resins can be cyclopentadiene homopolymers or cyclopentadiene copolymers. Dicyclopentadiene and substituted dicyclopentadiene resins, such as methyl-substituted dicyclopentadiene, may also be used.

Preferably, the HCR is a saturated alicyclic hydrocarbon resin. Saturated alicyclic HCRs utilized in the multilayer film may be obtained by hydrogenation of aromatic hydrocarbon resins. The aromatic resins can be obtained by polymerizing reactive unsaturated hydrocarbons containing aromatic hydrocarbons in which reactive double bonds are generally in side-chains. The saturated alicyclic resins can be obtained from the aromatic resins by hydrogenating the latter until all, or almost all, of the unsaturation has disappeared, including the double bonds in the aromatic rings. Although exemplary aromatic hydrocarbons useful in the preparation of the alicyclic resins can be compounds containing reactive double bonds in side-chains, they may also comprise aromatic hydrocarbons having reactive double bonds in condensed ring systems. Examples of such useful aromatic hydrocarbons include vinyltoluene, vinylxylene, propenylbenzene, styrene, methylstyrene, indene, methylindene, and ethylindene. Mixtures of several of these hydrocarbons may also be used. Examples of suitable commercially available alicyclic resins include ARKON® resins by Arakawa Chemical Industries, Ltd. of Osaka, Japan.

Examples of suitable commercially available HCRs include PICCOLYTE® resins from Hercules Incorporated of Wilmington, Del.; REGALREZ® and REGALITE® resins from Eastman Chemical Company of Kingsport, Tenn.; and ESCOREZ® and OPPERA® resins from ExxonMobil Chemical Company of Houston, Tex.

In one embodiment, the core layer may include a masterbatch of polypropylene and a HCR. It may be useful to use a masterbatch in order to ensure sufficient dispersion of the HCR throughout the core layer. An example of a suitable masterbatched HCR is, for example, PA610A, which is a masterbatch of 50% HCR and 50% polypropylene (commercially available from ExxonMobil Chemical Company). In one embodiment, the HCR is hydrogenated and has a softening point of about 140° C. and a weight average molecular weight (Mw) of 500 g/mole and is blended into a masterbatch with polypropylene.

The nucleating agent and water vapor transmission inhibitor may be substantially evenly distributed or dispersed at least laterally throughout the core layer. The nucleating agent incorporated into the core layer may be present in an amount, for example, of up to about 3000 ppm (parts-per-million) of the resin of the core layer or, for example, in an amount of about 25 ppm to about 1000 ppm or 3 wt % or 4 wt % or 5 wt %, or in an amount of about 50 ppm to about 200 ppm. The water vapor transmission inhibitor may be present in an amount, for example, of up to about 30 wt %, preferably up to about 15 wt %, of the core layer. In some embodiments, the water vapor transmission inhibitor is a HCR and may be present in the core layer in an amount up to about 30 wt %, preferably from about 2 wt % to about 15 or 20 or 25 wt %, more preferably from about 3 wt % to about 10 wt %, relative to the core layer.

The core layer may further comprise at least one additive in addition to the nucleating agent and the hydrocarbon resin. Examples of useful additives are opacifying agents, pigments, colorants, cavitating agents, slip agents, antioxidants, anti-fog agents, anti-static agents, fillers, and combinations thereof. Preferably, the total amount of additives in the core layer (other than the HCR and nucleating agent) may comprise up to about 20 wt % of the core layer, but in some embodiments, up to about 30 wt % of the core layer based on the total weight of the core layer.

### Tie Layer

The multilayer film of this disclosure may optionally comprise one or more tie layers. As is known to those skilled in the art, the tie layer of a multilayer film is typically used to connect two other partially or fully incompatible layers of the multilayer film structure, e.g., a core layer and a skin layer, and is typically positioned intermediate these layers.

In one embodiment, there is a first tie layer located intermediate the core layer and the sealant skin layer. The first tie layer may be in direct contact with the surface of the core layer or, in other embodiments, another layer or layers may be intermediate the core layer and the first tie layer.

In another embodiment, a second tie layer is optionally present and is located intermediate the core layer and the outer skin layer.

In some preferred embodiments, the tie layer may comprise an adhesion promoting material such as a maleic anhydride modified polypropylene, an example of which is ADMER™ AT1179A (available from Mitsui Chemicals America, Inc.).

In some embodiments, the tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof.

The thickness of the tie layer is typically in the range of about 0.50 μm to about 25 μm, preferably about 0.50 μm to about 12 μm, more preferably about 0.50 μm to about 6 μm, and most preferably about 2.5 μm to about 5.0 μm. However, in some thinner films, the tie layer thickness may be in the range of about 0.5 μm to about 4 μm, or about 0.5 μm to about 2 μm, or about 0.5 μm to about 1.5 μm.

The thickness of the second tie layer may be in the range of about 0.50 μm to about 25 μm, preferably from about 1 μm to about 12 μm, and most preferably from about 1.0 μm to about 10.0 μm. Also, the thickness may be in the range of about 0.5 μm to about 8.0 μm, or about 1.0 μm to about 6.0 μm, or about 1.0 μm to about 4.0 μm.

### Outer Skin Layer

An outer skin layer is an optional layer and when present is provided on the opposite side of the core layer from the sealant layer. The skin layer may be contiguous to the core layer or contiguous to one or more other layers positioned intermediate the core layer and the skin layer. The skin layer may be provided to improve the film's barrier properties, processability, printability, and/or compatibility for metallization, coating, and lamination to other films or substrates.

The outer skin layer may comprise a polymer that provides a printable or metallizable layer or that enhances processability of the film. For example, in some embodiments the outer skin layer may comprise a polymer selected from the group consisting of polyethylene (PE), PP polymer, an EP copolymer, an EPB terpolymer, a PB copolymer, an ethylene-vinyl alcohol (EVOH) polymer, and combinations thereof. Preferably, the PE polymer is high-density polyethylene (“HDPE”), such as M-6211 and HDPE M-6030 (both available from Equistar Chemical Company) or HD-6704.67 (commercially available from ExxonMobil Chemical Company); and preferably the PP polymer is an EP copolymer, such as EP-8573 (commercially available from Total Petrochemical Company).

For coating and printing functions, the outer skin layer may preferably comprise a co- or terpolymer that has been surface treated. For metallizing or barrier properties, a HDPE, PP, PB copolymer, or EVOH may be preferred. A suitable EVOH copolymer is Eval G176B (commercially available from Kuraray Company Ltd. of Japan).

The skin layer may also comprise processing aids or additives such as anti-block agents, anti-static agents, slip agents, and combinations thereof.

The thickness of the skin layer depends upon the intended function of the skin layer, but is typically in the range of about 0.50 μm to about 3.5 μm, preferably from about 0.50 μm to about 2 μm, and most preferably from about 0.50 μm to about 1.5 μm. Also, in thinner film embodiments, the second skin layer thickness may range from about 0.50 μm to about 1.0 μm or about 0.50 μm to about 0.75 μm.

### Second Tie Layer

In some forms of the multi-layer films invention, an optional second tie layer forms a region of the core layer that is in surface contact with the outer skin layer. Such second tie layer forms the second surface of the core layer that is contiguous to the first surface of the outer skin layer. In some preferred forms, the second tie layer is an adhesion promoting material, such as Admer AT 1179A (commercially available from Mitsui Chemicals America Inc.), a maleic anhydride-modified polypropylene.

The thickness of the second tie layer is in the range of from about 1 μm to about 10 μm; preferably from about 1 μm to about 4 μm; and most preferably from about 2 μm to about 3 μm. In other embodiments, the thickness may be from about 0.5 μm to about 8 μm; or from about 1 μm to about 6 μm.

### Coating

In some forms, one or more coatings, such as for barrier, printing, and/or processing, may be applied to the outer skin layer of the multi-layer films disclosed herein. Such coatings may include acrylic polymers, such as ethylene acrylic acid (EAA), ethylene methyl acrylate copolymers (EMA), polyvinylidene chloride (PVdC), poly(vinyl)alcohol (PVOH), and ethylene (vinyl)alcohol EVOH. The coatings are preferably applied by an emulsion coating technique, but may also be applied by co-extrusion and/or lamination.

The PVdC coatings that are suitable for use with the multi-layer films of this invention are any of the known PVdC compositions heretofore employed as coatings in film manufacturing operations, e.g., any of the PVdC materials described in U.S. Pat. Nos. 4,214,039; 4,447,494; 4,961,992; 5,019,447; and 5,057,177; incorporated herein by reference.

Known vinyl alcohol-based coatings, such as PVOH and EVOH, that are suitable for use with the multi-layer films invention include VINOL 125 or VINOL 325 (both commercially available from Air Products, Inc.). Other PVOH coatings are described in U.S. Pat. No. 5,230,963, incorporated herein by reference.

### Additives

One or more layers of the multilayer film may further contain one or more additives. Examples of useful additives include, but are not limited to, opacifying agents, pigments, colorants, cavitating agents, slip agents, antioxidants, anti-fog agents, anti-static agents, anti-block agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required.

Examples of suitable opacifying agents, pigments, or colorants include, but are not limited to, iron oxide, carbon black, aluminum, titanium dioxide, calcium carbonate, poly terephthalate, talc, beta nucleating agents, and combinations thereof.

Cavitating agents or void-initiating particles may be added to one or more layers of the multilayer film to create an opaque film. Preferably, the cavitating agents or void-initiating particles are added to the core layer. Generally, the cavitating or void-initiating additive includes any suitable organic or inorganic material that is incompatible with the polymer material(s) contained in the layer(s) to which the cavitating or void-initiating additive is added, at the temperature of biaxial orientation. Examples of suitable void-initiating particles include, but are not limited to, polybutylene terephthalate (“PBT”), nylon, cyclic-olefin copolymers, solid or hollow pre-formed glass spheres, metal beads or spheres, ceramic spheres, calcium carbonate, talc, chalk, or combinations thereof. The average diameter of the void-initiating particles typically ranges from about 0.1 μm to about 10 μm. The particles may be of any desired shape, or preferably they are substantially spherical in shape. Preferably, the cavitating agents or void-initiating particles are present in the layer at less than 30 wt %, or less than 20 wt %, or most preferably in the range of 2 wt % to 10 wt %, based on the total weight of the layer. Alternatively, one or more layers of the multilayer film may be cavitated by beta nucleation, which includes creating beta-form crystals of polypropylene and converting at least some of the beta-crystals to alpha-form crystals thus leaving small voids remaining after the conversion.

Slip agents that may be used include, but are not limited to, higher aliphatic acid amides, higher aliphatic acid esters, waxes, silicone oils, and metal soaps. Such slip agents may be used in amounts in the range of 0.1 wt % to 2 wt % based on the total weight of the layer to which it is added. An example of a fatty acid slip additive that may be used is erucamide. In one embodiment, a conventional polydialkylsiloxane, such as silicone oil or silicone gum, additive having a viscosity of 10,000 to 2,000,000 cSt is used.

Non-migratory slip agents may be used in one or more of the outer surface layers of the multilayer films. Non-migratory means that these agents do not generally change location throughout the layers of the film in the manner of migratory slip agents. A preferred non-migratory slip agent is polymethyl methacrylate (“PMMA”). The non-migratory slip agent may have a mean particle size in the range of 0.5 μm to 15 μm, or 1 μm to 10 μm, or 1 μm to 5 μm, or 2 μm to 4 μm, depending on the layer's thickness and desired slip properties. Alternatively, the size of the particles in the non-migratory slip agent, such as PMMA, may be greater than 10% of the thickness of the surface layer containing the slip agent, or greater than 20% of the layer's thickness, or greater than 50% of the layer's thickness, or in some embodiments greater than 100% of the layer's thickness. Generally spherical, particulate non-migratory slip agents are contemplated. A commercially available example of a PMMA resins is EPOSTAR™, which is available from Nippon Shokubai Co., Ltd. of Japan.

An example of a suitable antioxidant includes phenolic anti-oxidants, such as IRGANOX® 1010, which is commercially available from Ciba-Geigy Company of Switzerland. Such an antioxidant may be used in an amount ranging from 0.1 wt % to 2 wt %, based on the total weight of the layer to which it is added.

Anti-static agents that may be used include alkali metal sulfonates, polyether-modified polydiorganosiloxanes, polyalkylpheylsiloxanes, tertiary amines, glycerol mono-sterate, blends of glycerol mono-sterate and tertiary amines, and combinations thereof. Such anti-static agents may be used in amounts in the range of about 0.05 wt % to 3 wt %, based on the total weight of the layer to which the anti-static is added. An example of a suitable anti-static agent is ARMOSTAT™ 475, commercially available from Akzo Nobel.

Useful antiblock additives include, but are not limited to, silica-based products such as inorganic particulates such as silicon dioxide, calcium carbonate, magnesium silicate, aluminum silicate, calcium phosphate, and the like. Other useful antiblock additives include polysiloxanes and non-meltable crosslinked silicone resin powder, such as TOSPEARLT™, which is commercially available from Toshiba Silicone Co., Ltd. Anti-blocking agents may be effective in amounts up to about 30,000 ppm of the layer to which it is added.

Examples of useful fillers include but are not limited to, finely divided inorganic solid materials such as silica, fumed silica, diatomaceous earth, calcium carbonate, calcium silicate, aluminum silicate, kaolin, talc, bentonite, clay, and pulp.

Suitable moisture and gas barrier additives may include effective amounts of low-molecular weight resins, hydrocarbon resins, particularly petroleum resins, styrene resins, cyclopentadiene resins, and terpene resins. The multilayer film may also contain a hydrocarbon wax in one or more layers. The hydrocarbon wax may be either a mineral wax or a synthetic wax. Hydrocarbon waxes may include paraffin waxes and microcrystalline waxes. Typically, paraffin waxes having a broad molecular weight distribution are preferred as they generally provide better barrier properties than paraffin waxes with a narrow molecular weight distribution.

Optionally, one or more of the outer surface layers may be compounded with a wax or coated with a wax-containing coating, for lubricity, in amounts in the range of 2 wt % to 15 wt %, based on the total weight of the layer.

### Film Orientation

The forms of this invention include possible uniaxial or, more preferably, biaxial orientation of the multi-layer films. Orientation in the direction of extrusion is known as machine direction orientation (MD), orientation perpendicular to direction of extrusion is known as transverse direction (TD). Orientation may be accomplished by stretching or pulling a blown film in the MD, using a blow-up ratio to accomplish TD orientation. Blown films or cast films may also be oriented by a tenter-frame orientation subsequent to the film extrusion process, again in one or both directions. Orientation may be sequential or simultaneous, depending upon the desired film features. Orientation ratios may generally be in the range of 1:3 to 1:6 in the machine direction (MD) or 1:4 to 1:10 in the transverse direction (TD). Preferred orientation ratios are commonly from between about three to about six times in the machine direction and between about four to about ten times the extruded width in the transverse direction.

### Surface Treatment

One or more of the surfaces of the outer layers of the multi-layer films of this invention may be surface-treated to increase the surface energy to render the film receptive to metallization, coatings, printing inks, and/or lamination. The surface treatment can be carried out according to one of the methods known in the art. Methods that include corona discharge, flame, plasma, chemical treatment, or treatment by means of a polarized flame.

### Metallization

One or both of the outer exterior surfaces of the multilayer film may be metallized. Generally, the metallized layer is one of the outer skin and/or sealant layers. However, if no skin or sealant layer is present, the surface of a core layer may be metallized. Such layers may be metallized using conventional methods, such as a vacuum deposition of a metal layer such as aluminum, copper, silver, chromium, or mixtures thereof.

Metallization is generally applied to whichever outermost surface of the film that has been treated. Metallization or coatings may be applied alone or in some cases together. When metallization and coatings are applied together, either may be applied first, followed by the other.

In some embodiments, the film may first be surface treated, for example by flame treatment, and then be treated again in the metallization chamber, for example by plasma treatment, immediately prior to being metallized.

### Substrate

A substrate is adhered to the surface of the multilayer film opposite the sealant layer. Exemplary substrates include cellulosic and synthetic polymer materials. Exemplary cellulosic materials include, e.g., numerous varieties of paper such as corrugated paperboard, craft paper, glassine, and cartonboard. Exemplary polymeric substrate materials include non-woven tissue, e.g., spunbonded polyolefin fiber, melt-blown microfibers, etc. In some embodiments, the polymeric material is an oriented film comprising polypropylene or polyester. Particular polymeric films include a metallized polypropylene film with heat sealable layer, or a polyester having a melting point of 175° C. to 200° C. Some embodiments may employ a suitable adhesive to bond the multilayer film to the substrate. Thus, in some embodiments, the multilayer film or the substrate includes an adhesive layer to form the surface contact between the multilayer polymeric film and the substrate. Exemplary adhesives include hot melt adhesives, e.g., low density polyethylene, ethylene-methacrylate copolymers, polyvinylidene chloride latexes, polyurethanes, and acrylic coatings.

### Heat Seals

Heat seals useful in packaging are commonly lap, fin, or crimp seals. Most frequently, vertical form fill and seal and/or horizontal form fill and seal (VFFS and/or HFFS, respectively) useful in snack packaging will employ a fin seal and two crimp seals. Films of the present invention are particularly suitable for forming lap seals.

### Methods and Uses

Multi-layer films disclosed herein are useful as substantially stand-alone film webs or they may be coated, metallized, and/or laminated to other film structures. Multi-layer films disclosed herein may be prepared by any suitable methods that comprise the steps of co-extruding a multi-layer film according to the description and claims of this specification, orienting and preparing the film for intended use such as by coating, printing, slitting, or other converting methods. Preferred methods comprise co-extruding, then casting and orienting, or blowing a five-layer film, such as illustrated and discussed in the examples and in this specification.

In one form, a method of preparing a multilayer film is provided. The method comprises the step of co-extruding a core layer having a first surface and a second surface, the core layer comprising a core polymer and a sealant layer adjacent the first surface of the first tie layer, the sealant layer comprising an anti-blocking agent and having a 45° surface gloss ≦20.0, wherein a top seal and/or side seal of the sealant layer to itself has a seal strength >about 5.0×10², e.g. 5.0×10² to 6.0×10², grams per inch at 127° C.

In another form, a method of preparing a multilayer film is provided. The method comprises co-extruding at least a core layer having a first surface and a second surface. The core layer comprises a core polymer. A first polymeric tie layer has a first surface and a second surface, the second surface being adjacent to the first surface of the core layer. A polymeric sealant layer is adjacent to the first surface of the first tie layer. The sealant layer is characterized by a 45° surface gloss ≦20.0, enclosing a product or article within at least a portion of the co-extruded film, engaging a first portion of the sealant skin layer with a second portion of the sealant skin layer at a seal layer and applying pressure and heat at the seal area to cause the first portion to engage with the second portion to create at least top seal and/or side seal, the top seal and/or side seal of the sealant layer to itself has a seal strength >about 5.0×10², e.g. 5.0×10² to 6.0×10², grams per inch at 127° C. The prepared multi-layer film may be used as a flexible packaging film, such as to package an article or good, such as a food item or other product. In some applications, the film may be formed into bags for snack foods.

### Property Measurements

Heat seal strength is a measure of the force required to separate a test strip of a material containing a seal and identifies the mode of failure of the test strip. The seal strength is generally performed on a surface that is sealed to itself. The film may or may not be laminated prior to the test. A sealing machine such as a Lako Tool seal machine is used to create the seal and measure the seal strength. A one inch strip of the film or lamination is cut and folded seal face to seal face. The strip is mounted on the sample holder which automatically inserts the folded strip between the seal jaws. The jaws, which can have a crimp pattern or can be flat, then come together with a set pressure and temperature to create the heat seal. The seal strength is measured automatically by a device which separates the layers of film and measures the force required to open the seal.

Minimum seal temperature (MST) is a measure of the sealing property of a film and is the temperature at which a heat seal may support a given force. The seal range is the maximum temperature that the structure seals prior to severe distortion due to sealing heat, minus the MST.

Gloss is a measure of the luster of a surface. The film to be measured is put on a black background. An incident light beam strikes the surface of the film at a 45° angle. A sensor measures the amount of light that is reflected by the film. The gloss is the ratio of the reflected light to the incident light expressed as a value generally between 0 and 100 although values greater than 100 are possible. A BYK Gardner Mini-gloss 45° is one instrument used to measure gloss.

The kinetic coefficient of friction (“COF”) was determined according to ASTM 1895 with 25 seconds of measuring time using a TMI Model 32-06 lab slip and friction testing equipment (commercially available from Testing Machines Inc. of Ronkonkoma, N.Y.). A 200 g sled comprised of 3/16 inch sponge rubber with 17 to 24 psi compressibility, is preferred.

The surface roughness (Ra) of the film samples were measured using a surface profilometer (Mahr Federal Perthometer M2 with PFM Drive Unit) according to ISO 4287. The film sample to be tested should be wrinkle and contamination free. Multiple locations are measured across the sample in the TD. The pick-up (stylus) is placed in the measuring position. The tracing-arm is placed on the sample so that the stylus pulls across the TD of the sample surface to be measured. Testing is performed from the right edge of the film surface to center to left edge of the film, in order to prevent contamination of the testing area from the stylus. The Ra value is the arithmetic average of the absolute values of the roughness profile ordinates of the film's surface.

The Mahr Federal Perthometer was also used to determine the peak count (Pc) of the film. The peak count is a unitless measure of the number of roughness profile elements per one inch (2.54 cm) of film. Even though the stylus will travel over a shorter distance, the instrument uses a ratio-and-proportion algorithm to determine what the counts would be over one inch (2.54 cm). In order to determine the peak count, a bandwith of ±0.51 μm was used for the bandwidth that is symmetrical about the mean line for a total bandwith of 1.02 μm. To be counted as a peak, the peak and valley combination must pass through both the top and bottom of this bandwith.

Sealing strength and range can be measured on a vertical form, fill, and seal (VFFS) packaging machine. An example is the Hayssen™ Ultima II available from Hayssen Packaging Technologies. The outer web, the outside of the final package, is first laminated to an appropriate inner web such as 70 MET-HB available from ExxonMobil Chemical Company. The film can be laminated using a water-based or solvent-based adhesive or an extruded polyethylene-based layer. This lamination is run through the packaging machine at 72 empty packages per minute. The lamination is formed into a cylinder by the forming collar and this cylinder runs along a tube that is normally used for filling the package. The end seal is created using reciprocating heated jaws with horizontal serrations which compress and apply heat to the ends of the formed cylinder. The back seal or lap seal, where the inside surface has to seal to the outside surface, is made using a heated reciprocating platen that applies heat and pressure to the overlapped film layers and the fill tube on the machine. The crimp or lap seal strength is measured by cutting a 25 mm wide sample across the seal and measuring the force required to peel apart the seal using an Alfred-Suter seal strength testing machine. For the lap seal the minimum sealing temperature (MST) is achieved when the platen temperature causes the seal strength to exceed 100 g/25 mm. For the crimp seal, the MST is achieved when the crimp jaw temperature causes the seal strength to exceed 200 g/25 mm. The ultimate seal temperature (UST) is the temperature that causes the lamination to distort too severely to measure a seal strength. The seal range is the difference between the UST and the MST.

Force over forming color (FOFC) can also be measured on a VFFS machine. A Mira Pak Mira-matic Model L is set-up with a laminated structure as described above. The lamination is threaded over a forming collar, a device which forms the lamination into a cylinder prior to sealing and filling. Rather than seal and fill the structure, in this test the lamination is pulled through the machine and the force required to pull the film is measured using a force gauge such as a Dillon electronic force gauge made by W.C. Dillon & Company. Through forming the package, the friction between outer web and the forming collar changes the force required to pull the lamination through the machine. A ‘good’ outer web will generate a low FOFC, while a ‘bad’ outer web will have a higher FOFC.

Hot slip is measured on the Mira Pak by creating a back seal at a set temperature and then measuring FOFC. On a Mira Pak the back seal is created by overlapping the ends of the formed cylinder so the inside and outside of the lamination are facing each other. This overlapped area slides between two platens, one of which is heated. With the addition of this heat, the force required to pull the lamination through the machine normally increases. With a good outer web the force required will not increase substantially when the heat is increased.

### Particular Embodiments

1. Embodiments of the invention include a heat-sealable, oriented, multilayer film comprising:
i) a polyolefin core layer; and
ii) a heat-sealable layer comprising a blend, wherein the blend comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.).
   2. Embodiments of the invention include the films of Embodiment 1, wherein the propylene-based elastomer is characterized by an isotactic propylene triad tacticity of from 65% to 95%, a melting point by DSC ≦110° C., a heat of fusion of from 5.0 to 50.0 J/g, the propylene-based elastomer comprising:
(i) propylene-derived units in an amount of at least 75 wt %; based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).
   3. Embodiments of the invention include the films of Embodiment 2, wherein the propylene-based elastomer comprises <18.0 wt % ethylene-derived units.
   4. Embodiments of the invention include the films of Embodiment 3, wherein the propylene-based elastomer comprises >15.0 wt % ethylene-derived units.
   5. Embodiments of the invention include the films of any of Embodiments 1 to 4,

wherein the propylene-based elastomer comprises units derived from ethylene and <1.0 wt % of units derived from butene.

6. Embodiments of the invention include the films of any of Embodiments 1 to 5, wherein the heat-sealable skin layer comprises 5.0 wt % to 35.0 wt % of the propylene-based elastomer, wherein the propylene-based elastomer has a Vicat softening temperature of 50.0° C. to 85.0° C.
7. Embodiments of the invention include the films of Embodiment 1, wherein the propylene-based elastomer comprises butene-derived units and <1.0 wt % of units derived from ethylene and the propylene-based polymer comprises a propylene-ethylene random copolymer comprising <15.0 wt % units derived from ethylene and <1.0 wt % of units derived from butene.
8. Embodiments of the invention include films comprising:
a) a polyolefin-containing core layer; and
b) a heat-sealable layer comprising 15.0 wt % to 30.0 wt % of a propylene-butene copolymer elastomer and 70.0 wt % to 85.0 wt % of a propylene-ethylene random copolymer, the heat-sealable layer having a Haze of ≦5.0 and a seal strength of ≧2.00×10² g/2.54 cm at 82° C. (180° F.).
   9. Embodiments of the invention include films according to Embodiment 8, wherein the propylene-butene copolymer elastomer comprises 20 wt % to 40 wt %, preferably 24 wt % to 30 wt %, units derived from butene.
   10. Embodiments of the invention include films according to Embodiments 8 and 9, wherein the propylene-butene copolymer elastomer has a melting point <90.0° C., preferably <85.0° C.
   11. Embodiments of the invention include films according to any of Embodiments 8 to 10, wherein the propylene-butene copolymer elastomer has a Vicat softening temperature of <85.0° C., preferably <75.0° C., more preferably <70.0° C.
   12. Embodiments of the invention include films according to any of Embodiments 8 to 11, wherein the propylene-butene copolymer elastomer has a density <0.890 g/cm³, preferably from 0.882 g/cm³ to 0.887 g/cm³.
   13. Embodiments of the invention include films according to any of Embodiments 8 to 12, wherein the propylene-ethylene random copolymer has a density of 0.870 g/cm³ to 0.910 g/cm³ and an MFR, according to ASTM D-1238 at 2.16 kg and 230° C. of 3.0 to 10.0 g/10 min.
   14. Embodiments of the invention also include methods of making a heat-sealable, oriented film, the method comprising:
a) coextruding a film comprising i) a polyolefin core layer; and ii) a heat-sealable layer comprising a blend, wherein the blend comprises 10.0 wt % to 50.0 wt % of a propylene-based elastomer and 50.0 wt % to 90.0 wt % of a propylene-based polymer compatible with the propylene-based elastomer;
b) orienting the film in the machine direction, wherein the heat-sealable layer contacts one or more one or more rollers; and
c) optionally orienting the film in the transverse direction.
   15. Embodiments of the invention include methods according to Embodiment 14, further including quenching the coextruded multilayer polymeric film utilizing a chilled casting roll system or casting roll and water bath system.
   16. Embodiments of the invention include methods according to Embodiments 14 and 15,

wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.).

17. Embodiments of the invention include methods according to any of Embodiments 14 to 16, wherein the propylene-based elastomer is characterized by an isotactic propylene triad tacticity of from 65% to 95%, a melting point by DSC ≦110° C., a heat of fusion of from 5.0 to 50.0 J/g, the propylene-based elastomer comprising:
(i) propylene-derived units in an amount of at least 75 wt %, based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).
   18. Embodiments of the invention include methods according to any of Embodiments 14 to 17, wherein the propylene-based elastomer ethylene-derived units in an amount <18.0 wt %.
   19. Embodiments of the invention include methods according to any of Embodiments 14 to 18, wherein the propylene-based elastomer comprises units derived from ethylene and <1.0 wt % of units derived from butene.
   20. Embodiments of the invention include methods according to any of Embodiments 14 to 19, wherein the heat-sealable skin layer comprises 5.0 wt % to 35.0 wt % of the propylene-based elastomer, wherein the propylene-based elastomer has a Vicat softening temperature of 50.0° C. to 85.0° C.
   21. Embodiments of the invention include methods according to any of Embodiments 14 to 20, wherein the propylene-based elastomer comprises propylene-derived units, butene-derived units, and <1.0 wt % of units derived from ethylene and the propylene-based polymer comprises a propylene-ethylene random copolymer comprising <15.0 wt % units derived from ethylene and <1.0 wt % of units derived from butene.
   22. Embodiments of the invention include methods according to Embodiment 14, wherein the heat-sealable layer comprising 15.0 wt % to 30.0 wt % of a propylene-butene copolymer elastomer and 70.0 wt % to 85.0 wt % of a propylene-ethylene random copolymer, the heat-sealable layer having a Haze of ≦5.0 and a seal strength of ≧2.00×10² g/2.54 cm at 82° C. (180° F.).
   23. Embodiments of the invention include methods according to Embodiment 22, wherein the propylene-butene copolymer elastomer comprises 20 wt % to 40 wt %, preferably 24 wt % to 30 wt %, units derived from butene.
   24. Embodiments of the invention include methods according to any of Embodiments 22 and 23, wherein the propylene-butene copolymer elastomer has a melting point <90.0° C., preferably <85.0° C.
   25. Embodiments of the invention include methods according to any of Embodiments 22 to 24, wherein the propylene-butene copolymer elastomer has a Vicat softening temperature of <85.0° C., preferably <75.0° C., more preferably <70.0° C.
   26. Embodiments of the invention include methods according to any of Embodiments 22 to 25, wherein the propylene-butene copolymer elastomer has a density <0.890 g/cm³, preferably from 0.882 g/cm³ to 0.887 g/cm³.
   27. Embodiments of the invention include methods according to any of Embodiments 22 to 26, wherein the propylene-ethylene random copolymer has a density of 0.870 g/cm³ to 0.910 g/cm³ and an MFR, according to ASTM D-1238 at 2.16 kg and 230° C., of 3.0 to 10.0 g/10 min.
   28. Embodiments of the invention include heat-sealable, oriented, multilayer film comprising:
i) a polyolefin core layer; and
ii) a heat-sealable layer comprising a blend, wherein the blend comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧3.00×10² g/2.54 cm at 90° C. (194° F.).
   29. Embodiments of the invention include the heat-sealable, oriented, multilayer films of Embodiment 28, wherein the heat-sealable layer has a seal strength of ≧2.00×10² g/2.54 cm at 82° C. (180° F.).
   30. Embodiments of the invention include the heat-sealable, oriented, multilayer films of Embodiment 28 or 29, wherein the heat-sealable layer has a seal strength of ≧2.00×10² g/2.54 cm at 79° C. (175° F.).
   31. Embodiments of the invention include the heat-sealable, oriented, multilayer films of Embodiment 28 or 29, wherein the heat-sealable layer has a seal strength of 2.00×10² g/2.54 cm to 4.00×10² g/2.54 cm at 79° C. (175° F.).
   32. Embodiments of the invention include the heat-sealable, oriented, multilayer films of Embodiment 28 or 29, wherein the heat-sealable layer has a seal strength of ≧2.00×10² g/2.54 cm at 74° C. (165° F.).
   33. Embodiments of the invention include the heat-sealable, oriented, multilayer films of Embodiment 28 or 29, wherein the heat-sealable layer has a seal strength of 6.00×10² g/2.54 cm to 8.00×10² g/2.54 cm at 115° C. (239° F.).
   34. Embodiments of the invention include the heat-sealable, oriented, multilayer films of Embodiment 28 or 29, wherein the heat-sealable layer has a seal strength of ≧5.50×10² g/2.54 cm at 105° C. (221° F.).
   35. Embodiments of the invention include the heat-sealable, oriented, multilayer films of Embodiment 28 or 29, wherein the heat-sealable layer has a seal strength of 5.50×10² g/2.54 cm to 7.00×10² g/2.54 at 105° C. (221° F.).
   36. Embodiments of the invention include the heat-sealable, oriented, multilayer films of any of Embodiments 28 to 35, wherein the propylene-based elastomer is characterized by an isotactic propylene triad tacticity of from 65% to 95%, a melting point by DSC≦110° C., a heat of fusion of from 5.0 to 50.0 J/g, the propylene-based elastomer comprising:
(i) propylene-derived units in an amount of at least 75 wt %; based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).
   37. Embodiments of the invention include the heat-sealable, oriented, multilayer films of Embodiment 36, wherein the propylene-based elastomer comprises <18.0 wt % ethylene-derived units.
   38. Embodiments of the invention include the heat-sealable, oriented, multilayer films of Embodiment 37, wherein the propylene-based elastomer comprises >15.0 wt % ethylene-derived units.
   39. Embodiments of the invention include the heat-sealable, oriented, multilayer films of any of Embodiments 28 to 35, wherein the propylene-based elastomer comprises units derived from ethylene and <1.0 wt % of units derived from butene.
   40. Embodiments of the invention include the heat-sealable, oriented, multilayer films of any of Embodiments 28 to 35, wherein the heat-sealable skin layer comprises 5.0 wt % to 35.0 wt % of the propylene-based elastomer, wherein the propylene-based elastomer has a Vicat softening temperature of 50.0° C. to 85.0° C.
   41. Embodiments of the invention include the heat-sealable, oriented, multilayer films of any of Embodiments 28 to 35, wherein the propylene-based elastomer comprises butene-derived units and <1.0 wt % of units derived from ethylene and the propylene-based polymer comprises a propylene-ethylene random copolymer comprising <15.0 wt % units derived from ethylene and <1.0 wt % of units derived from butene.
   42. Embodiments of the invention include the heat-sealable, oriented, multilayer films of Embodiment 41, wherein the propylene-based elastomer comprises 20.0 wt % to 30.0 wt % units derived from butene; a melting point of 70° C. and 90° C.; a Vicat softening point of 60.0° C. to 80.0° C.; a density of 0.870 to 0.900 g/cm³.

### EXAMPLES

The multi-layer film of the present invention will be further described with reference to the following non-limiting examples. All weight percentages specified herein are based on the weight of the respective film layer, unless specified otherwise.

In the Examples, the multilayer films have a heat-sealable skin layer, a core layer, and an outer skin layer. Tie-layer regions of the coextrusion die comprise the same polypropylene composition used for the core layer. The outer skin layer is on the water-bath side. The heat-sealable skin layer is on the cast-roll side. An example of a representative film structure is shown in Table 1. The machine direction stretching is set at about 4.8× and the transverse direction stretching is set at 8.5×. The films are flame treated on the water bath side. The multilayer films are rolled and then slit to 15″ width on 3″ core, out to out, for lamination and packaging tests. The multilayer films are tested for various properties as reported in Table 3.

TABLE 1
Representative Film Structure of Films in Examples

| | | | Thickness | | |
|---|---|---|---|---|---|
| | Layer | Structure/Resin | μm | mil | % |
| Film | OUT | Flame Treatment | | | |
| | Skin | EPB Terpolymer Skin | 1.02 | 0.04 | 5.7 |
| | Tie | Polypropylene | 15.7 | 0.62 | 88.6 |
| | Core | Polypropylene | | | |
| | Tie | Polypropylene | | | |
| | Sealant Skin | Skin Blend | 1.02 | 0.04 | 5.7 |
| | IN | | | | |

### Example 1

In Example 1, the heat-sealable skin layer comprises 70.0 wt % of high ethylene-content, propylene-ethylene copolymer having a melt flow (g/10 min., ASTM D-1238, 230° C., 2.16 kg), a density of 0.895 g/cc (ASTM D-1505), a melting point of 135° C. (DSC) (Polypropylene 8573 HB from Total Petrochemicals), and 30.0 wt % of the propylene-butene elastomer Tafmer XM7070. The core layer and tie layer portions of the extrusion dies are used to form a core layer comprising polypropylene (PP-4712 from ExxonMobil Chemical Company). The outer skin layer comprises an EPB terpolymer (JPP7510 from Japan Polypropylene Corporation). The film is stretched in the machine direction via differential speed rollers the stretching being determined by the difference in speed of the rollers.

### Example 2

In Example 2, the film of Example 1 is substantially repeated except that the propylene-butene elastomer Tafmer XM7070, is replaced with Tafmer XM7080.

### Example 3

In Example 3, the film of Example 1 is substantially repeated, except that the sealant skin layer comprises 70.0 wt % of an EPB terpolymer (JPP7794 from Japan Polypropylene Corporation) and 30.0 wt % of propylene-based elastomer having an ethylene content of 8.5 wt %, a Vicat Softening Point of 80.0° C., a density of 0.874 g/cm³, a melt index of 3.6 g/10 min. (according to ASTM D1238 at 2.16 kg and 190° C.), and a MFR of 8.3 (according to ASTM D1238 at 2.16 kg and 230° C.), available as Vistamaxx™ 3980 from ExxonMobil Chemical Company. The film was stretched in the MD between 190° C. and 210° C. at a roller amperage of 7.7. Stretching in the TD direction is performed at a tenter amperage of 13.0.

### Example 4

In Example 4, the film of Example 3 is substantially repeated, except that the core includes 15.0 wt % of a hydrocarbon resin (Oppera™ 609 from ExxonMobil Chemical Company) 85.0 wt % polypropylene (PP-4712 from ExxonMobil Chemical Company). The film was stretched in the MD between 190° C. and 210° C. at a roller amperage of 7.3. Stretching in the TD direction is performed at a tenter amperage of 12.3.

### Example 5

In Example 5, the film of Example 3 is substantially repeated, except that the core includes 15.0 wt % of a hydrocarbon resin (Oppera™ 609 from ExxonMobil Chemical Company), 3.0 wt % of a nucleating agent (Millad 8H4i-10 from Milliken) and 82.0 wt % polypropylene (PP-4712 from ExxonMobil Chemical Company). The film was stretched in the MD between 203° C. and 223° C. at a roller amperage of 9.7. Stretching in the TD direction is performed at a tenter amperage of 13.5.

### Comparative Example 1

In Comparative Example 1, the sealant skin layer comprises an EPB terpolymer (JPP7794 from Japan Polypropylene Corporation). The core layer and tie layer portions of the extrusion dies are used to form a core layer comprising polypropylene (PP-4712 from ExxonMobil Chemical Company). The outer skin layer comprises an EPB terpolymer (JPP7510 from Japan Polypropylene Corporation).

### Comparative Example 2

Comparative Example 1 is substantially repeated except that the EPB terpolymer JPP-7794 is replaced with a low temperature Adsyl 7462 XCP polyolefin, specially designed for use as a sealing layer in co-extruded film applications (from LyondellBasell).

### Comparative Example 3

Comparative Example 1 is substantially repeated except that the EPB terpolymer JPP-7794 is replaced with SPX 79F5, a polypropylene copolymer supplied by Sumitomo Chemical having a melting point of 135° C.

Table 2 summarizes the film structures of the sample films in the examples. The films were tested for a variety of properties, with the results shown in Table 3.

TABLE 2
Example 1 Film Structures

| | Outer | | | | | | | |
|---|---|---|---|---|---|---|---|---|
| | Skin Layer | Core | Sealant Skin Layer | | | | | |
| | JPC | Layer | JPC | Basell | SPX | 8573 | TAFMER | VMX |
| | 7510 | PP-4712 | 7794 | 7462 | 79F5 | HB | 7070 | 3980 |
| Example 1 | 100% | 100% | 0% | 0% | 0% | 70.0% | 30.0% | 0 |
| Example 2 | 100% | 100% | 0% | 0% | 0% | 70.0% | 30.0% | 0 |
| Example 3 | 100% | 100% | 70.0% | 0% | 0% | 0% | 0% | 30.0% |
| Example 4 | 100% | 85.0% | 70.0% | 0% | 0% | 0% | 0% | 30.0% |
| Example 5 | 100% | 82.0% | 70.0% | 0% | 0% | 0% | 0% | 30.0% |
| Comp. Ex. 1 | 100% | 100% | 100.0% | 0% | 0% | 0% | 0% | 0% |
| Comp. Ex. 2 | 100% | 100% | 0% | 100% | 0% | 0% | 0% | 0% |
| Comp. Ex. 2 | 100% | 100% | 0% | 0% | 100.0% | 0% | 0% | 0% |

TABLE 3
Haze, Seal Performance and Hot Tack of Exemplary Films

| | | Lako seal | | | | | | | | Lako hot tack | | | |
|---|---|---|---|---|---|---|---|---|---|---|---|---|---|
| | | vertical jaw, g/2.54 cm | | | | | | | | vertical jaw | | | |
| | Haze | (60 psi, 0.75 sec dwell, 20 sec cooling) | | | | | | | | (60 psi, 0.75 sec dwell, no cooling) | | | |
| Example | % | 160 F. | 170 F. | 180 F. | 190 F. | 200 F. | 220 F. | 240 F. | MST | 200 F. | 220 F. | 240 F. | 260 F. |
| CE1 | 1.5 | | | 177 | 204 | 294 | 603 | 547 | 190.5 | | 257 | 378 | 313 |
| (2167-93 19118-095) | | | | | | | | | | | | | |
| CE2 | 1.1 | | | 166 | 212 | 297 | 510 | 531 | 190.3 | | 257 | 375 | 338 |
| (2167-93 19119-096) | | | | | | | | | | | | | |
| CE3 | 1.6 | | | | 141 | 215 | 438 | 595 | 198.0 | | 197 | 297 | 340 |
| (2167-93 19220-097) | | | | | | | | | | | | | |
| Ex. 1 | 1.1 | 139 | 326 | 410 | 396 | 453 | 691 | 628 | 166.5 | 202 | 224 | 367 | 312 |
| (2167-93 19226-098) | | | | | | | | | | | | | |
| Ex. 2 | 1.1 | | 56 | 247 | 341 | 411 | 569 | 547 | 175.2 | 198 | 256 | 392 | 360 |
| (2167-93 19227-099) | | | | | | | | | | | | | |
| Ex. 3 | 1.5 | | | 210 | 255 | 402 | 590 | | | 330 | 422 | 376 | |
| (EMCCF-2150-89-11737) | | | | | | | | | | | | | |
| Ex. 4 | 1.4 | | 143 | 270 | 372 | 424 | 610 | | | 310 | 357 | 321 | |
| (EMCCF-2150-89-11741) | | | | | | | | | | | | | |
| Ex. 5 | 1.5 | | 150 | 378 | 644 | 638 | 750 | | | 430 | 476 | 365 | |
| (EMCCF-2150-89-11741) | | | | | | | | | | | | | |

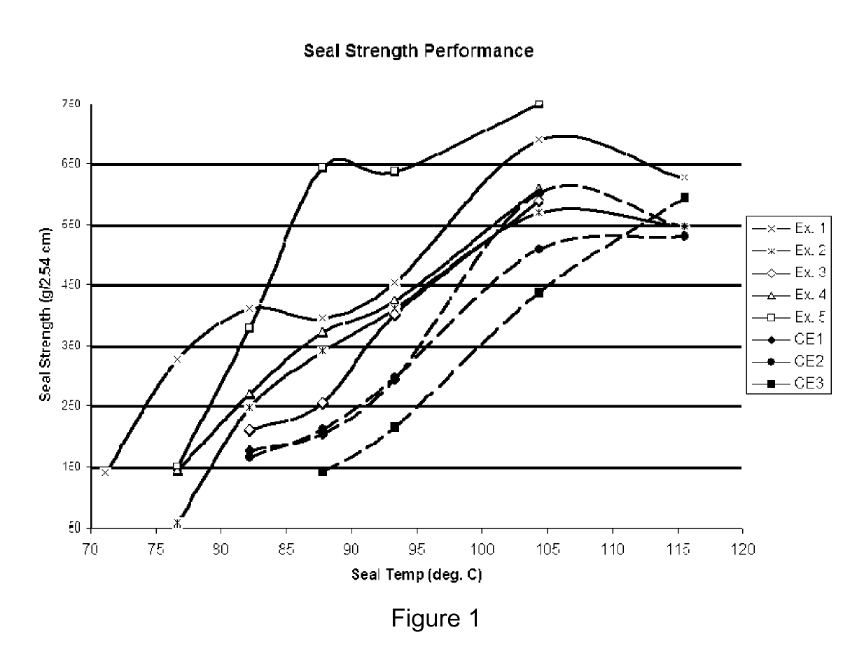

FIG. 1 illustrates the seal performance of the films of the examples. As this FIGURE shows, the films of Examples 1-5 each reach a seal strength of 200 g/2.54 cm at a lower temperature than Comparative Examples 1-3. It is particularly surprising that Example 1, wherein the heat-sealable skin layer comprises a propylene-ethylene copolymer and the propylene-butene elastomer TAFMER 7070 (22.0 wt % butene-content) performs better than conventional EPB terpolymer sealant resins. Thus, this example shows that relatively cost-effective propylene-ethylene copolymer not normal suitable for heat-sealable skin layers may be modified by the addition of modest amounts of the elastomer to obtain a sealant composition that is superior to the more costly and complication terpolymer compositions. Example 2 shows the same behavior, although the effect is not as pronounced. Examples 3-5 show that the performance of conventional EPB terpolymer sealant resins can be improved through the addition of modest amounts of a propylene-based elastomer. Not only are minimum seal temperatures improved, but over the range of temperatures between about 80° C. and 100° C., the seal strengths of each of Examples 1-5 is improved. Over the entire seal temperature range form about 70° C. to about 120° C., the seal strength of Examples 1 and 5 are significantly stronger than those of Comparative Examples 1-3.

To the extent that this description is specific, it is solely for the purpose of illustrating certain forms of the invention and should not be taken as limiting the present inventive concepts to these specific forms. Therefore, the spirit and scope of the appended claims should not be limited to the description of the forms contained herein.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all inventive features which reside herein, including all features which would be treated as equivalents thereof by those skilled in the art to which this disclosure pertains.

When numerical lower limits and numerical upper limits are listed herein, ranges from any lower limit to any upper limit are contemplated.

What is claimed is:

1. A heat-sealable, oriented, multilayer film comprising:
i) a polyolefin core layer; and
ii) a heat-sealable layer comprising a blend, wherein the blend comprises 10.0 wt % to 50.0 wt % of a propylene-based elastomer and 50.0 wt % to 90.0 wt % of a propylene-based polymer, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.).

2. The heat-sealable film of claim 1, wherein the propylene-based elastomer is characterized by an isotactic propylene triad tacticity of from 65% to 95%, a melting point by DSC ≦110° C., a heat of fusion of from 5.0 to 50.0 J/g, the propylene-based elastomer comprising:
(i) propylene-derived units in an amount of at least 75 wt %; based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).

3. The multi-layer film structure of claim 2, wherein the propylene-based elastomer comprises <18.0 wt % ethylene-derived units.

4. The multi-layer film structure of claim 3, wherein the core layer also comprise from 2 to 25 wt % of a hydrocarbon resin.

5. The heat-sealable film of claim 1, wherein the core layer also comprises from 25 ppm to 5 wt % of a nucleating agent based on the weight of the core layer.

6. The heat-sealable film of claim 1, wherein the heat-sealable skin layer comprises 15.0 wt % to 30.0 wt % of the propylene-based elastomer, wherein the propylene-based elastomer has a Vicat softening temperature of 50.0° C. to 85.0° C.

7. The heat-sealable film of claim 1, wherein the propylene-based elastomer comprises butene-derived units and <1.0 wt % of units derived from ethylene and the propylene-based polymer comprises a propylene-ethylene random copolymer comprising <15.0 wt % units derived from ethylene and <1.0 wt % of units derived from butene.

8. A heat-sealable, oriented, multilayer film comprising:
a) a polyolefin-containing core layer; and
b) a heat-sealable layer comprising 15.0 wt % to 30.0 wt % of a propylene-butene copolymer elastomer and 70.0 wt % to 85.0 wt % of a propylene-ethylene random copolymer, the heat-sealable layer having a Haze of ≦5.0 and a seal strength of ≧2.00×10² g/2.54 cm at 82° C. (180° F.).

9. The heat-sealable, oriented, multilayer film of claim 8, wherein the propylene-butene copolymer elastomer comprises 20 wt % to 40 wt %, preferably 24 wt % to 30 wt %, units derived from butene.

10. The heat-sealable, oriented, multilayer film of claim 8, wherein the propylene-butene copolymer elastomer has a melting point <90.0° C., preferably <85.0° C.

11. The heat-sealable, oriented, multilayer film of claim 8, wherein the propylene-butene copolymer elastomer has a Vicat softening temperature of <85.0° C., preferably <75.0° C., more preferably <70.0° C.

12. The heat-sealable, oriented, multilayer film of claim 8, wherein the propylene-butene copolymer elastomer has a density <0.890 g/cm³, preferably from 0.882 g/cm³ to 0.887 g/cm³.

13. The heat-sealable, oriented, multilayer film of claim 8, wherein the propylene-ethylene random copolymer has a density of 0.870 g/cm³ to 0.910 g/cm³ and an MFR, according to ASTM D-1238 at 2.16 kg and 230° C., of 3.0 to 10.0 g/10 min.

14. A method of making a heat-sealable, oriented film, the method comprising:
a) coextruding a film comprising i) a polyolefin core layer and ii) a heat-sealable layer comprising a compatible blend, wherein the compatible blend comprises 10.0 wt % to 50.0 wt % of a propylene-based elastomer and 50.0 wt % to 90.0 wt % of a propylene-based polymer compatible with the propylene-based elastomer;
b) orienting the film in the machine direction, wherein the heat-sealable layer contacts one or more one or more rollers; and
c) optionally orienting the film in the transverse direction.

15. The method of claim 14, further including quenching the coextruded multilayer polymeric film utilizing a chilled casting roll system or casting roll and water bath system.

16. The method of claim 14, wherein the heat-sealable layer includes less than 1.0 wt % ethylene homopolymer or ethylene-based copolymer and wherein the heat-sealable layer has a Haze of ≦5.0 and a seal strength of ≧2.00×10² g/2.54 cm at 82° C. (180° F.).

17. The method of claim 14, wherein the propylene-based elastomer is characterized by an isotactic propylene triad tacticity of from 65% to 95%, a melting point by DSC ≦110° C., a heat of fusion of from 5.0 to 50.0 J/g, the propylene-based elastomer comprising:
(i) propylene-derived units in an amount of at least 75 wt %, based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).

18. The method of claim 14, wherein the propylene-based elastomer comprises ethylene-derived units in an amount <18.0 wt %.

19. The method of claim 14, wherein the propylene-based elastomer comprises units derived from ethylene and <1.0 wt % of units derived from butene.

20. The method of claim 14, wherein the heat-sealable skin layer comprises 5.0 wt % to 35.0 wt % of the propylene-based elastomer, wherein the propylene-based elastomer has a Vicat softening temperature of 50.0° C. to 85.0° C.

21. The method of claim 14, wherein the propylene-based elastomer comprises propylene-derived units, butene-derived units, and <1.0 wt % of units derived from ethylene and the propylene-based polymer comprises a propylene-ethylene random copolymer comprising <15.0 wt % units derived from ethylene and <1.0 wt % of units derived from butene.

22. The method of claim 14, wherein the heat-sealable layer comprises 15.0 wt % to 30.0 wt % of a propylene-butene copolymer elastomer and 70.0 wt % to 85.0 wt % of a propylene-ethylene random copolymer, the heat-sealable layer having a Haze of ≦5.0 and a seal strength of ≧2.00×10² g/2.54 cm at 82° C. (180° F.).

23. The method of claim 22, wherein the propylene-butene copolymer elastomer comprises 20 wt % to 40 wt % units derived from butene.

24. The method of claim 22, wherein the propylene-butene copolymer elastomer has a melting point <90.0° C.

25. The method of claim 22, wherein the propylene-butene copolymer elastomer has a Vicat softening temperature of <85.0° C.
